(19) United States
(12) Patent Application Publication
(10) Pub. No.: US 2012/0127079 A1
(43) Pub. Date: May 24, 2012

(54) ELECTRODE INTERCONNECT

(75) Inventors: Matthew J. TREND, Fareham (GB); Paul Clements, (US)

(73) Assignee: QRG LIMITED

(21) Appl. No.: 12/952,801

(22) Filed: Nov. 23, 2010

(51) Int. Cl. G06F 3/02; G06F 3/042

(52) U.S. Cl. 345/168; 345/175

(57) ABSTRACT

An electrode of a touch position sensing panel has a light-transmitting conductor and an auxiliary conductor connected to the light-transmitting conductor.

### BACKGROUND

A position sensor can detect the presence and location of a touch, by a finger or by an object such as a stylus or a key of a keypad within an area of an external interface of the position sensor. Position sensors can be combined with devices having displays, such as touch screens, including but not limited to computers, personal digital assistants, satellite navigation devices, mobile telephones, portable media players, portable game consoles, public information kiosks, and point of sale systems. Position sensors have also been used as control panels on various appliances.

There are a number of different types of touch screens, such as resistive touch screens, surface acoustic wave touch screens, capacitive touch screens, etc. A capacitive touch screen, for example, may include an insulator coated with a transparent conductor in a particular pattern. There can be a change in capacitance when a finger or an object touches the surface of the screen. This change in capacitance may be sent to a controller for processing to determine the position of the touch.

For applications in which position sensor transparency is desired, touch screen electrode layers may be made of solid shapes of etched transparent conductive material, such as indium tin oxide (ITO). In a mutual capacitance sensor, for example, drive electrodes may be provided on one surface of a substrate and sense electrodes may be provided on a different surface of the substrate. Connecting lines may be formed between each electrode and one or more control or sensing units. Touch-sensitive nodes may be formed at the intersections of the drive and sense electrodes.

Transparent conductive materials may have relatively low conductivity compared to other conductive materials such as metals. Consequently, the resistance between the point at which a transparent electrode is connected to a connecting line and a point on the electrode remote from the connecting point may be undesirably high, particularly for relatively large area touch position sensors with relatively long sense or drive electrodes.

### SUMMARY

An electrode of a touch position sensing panel has a light-transmitting conductor and an auxiliary conductor connected to the light-transmitting conductor.

### BRIEF DESCRIPTION OF THE FIGURES

The figures depict one or more implementations in accordance with the present teachings by way of example, not by way of limitation. In the figures, like reference numerals refer to the same or similar elements.

FIG. 1 illustrates schematically the arrangement of drive and sense electrodes of an exemplary touch position sensing panel;

FIG. 2 illustrates schematically the sense electrodes of FIG. 1 in isolation;

FIG. 3A illustrates schematically a cross section of a first exemplary arrangement of elements of a touch position sensing panel;

FIG. 3B illustrates schematically a cross section of a second exemplary arrangement of elements of a touch position sensing panel; and

FIG. 4 illustrates schematically an exemplary touch sensitive device having a keypad and the exemplary position sensing panel of FIG. 1.

### DETAILED DESCRIPTION

In the following detailed description, numerous specific details are set forth by way of examples in order to explain the relevant teachings. In order to avoid unnecessarily obscuring aspects of the present teachings, methods, procedures, components, or circuitry that are well-known to one of ordinary skill in the art have been described at a relatively high level.

Reference now is made in detail to the examples illustrated in the accompanying figures and discussed below.

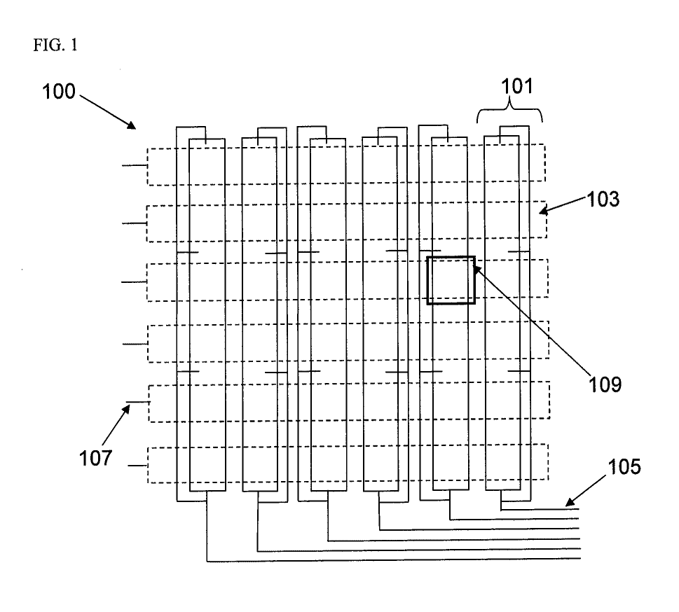

FIG. 1 illustrates an exemplary arrangement of drive electrodes 103 and sense electrodes 101 of a capacitive touch position sensing panel 100. Capacitive sensing channels may be formed at the capacitive coupling nodes 109 which are in the localized regions surrounding where the drive and sense electrodes 103 and 101 overlap each other. Connecting lines 105 and connecting lines 107 may connect the sense electrodes 101 and drive electrodes 103 respectively to one or more driving, sensing and/or control units, which are not shown.

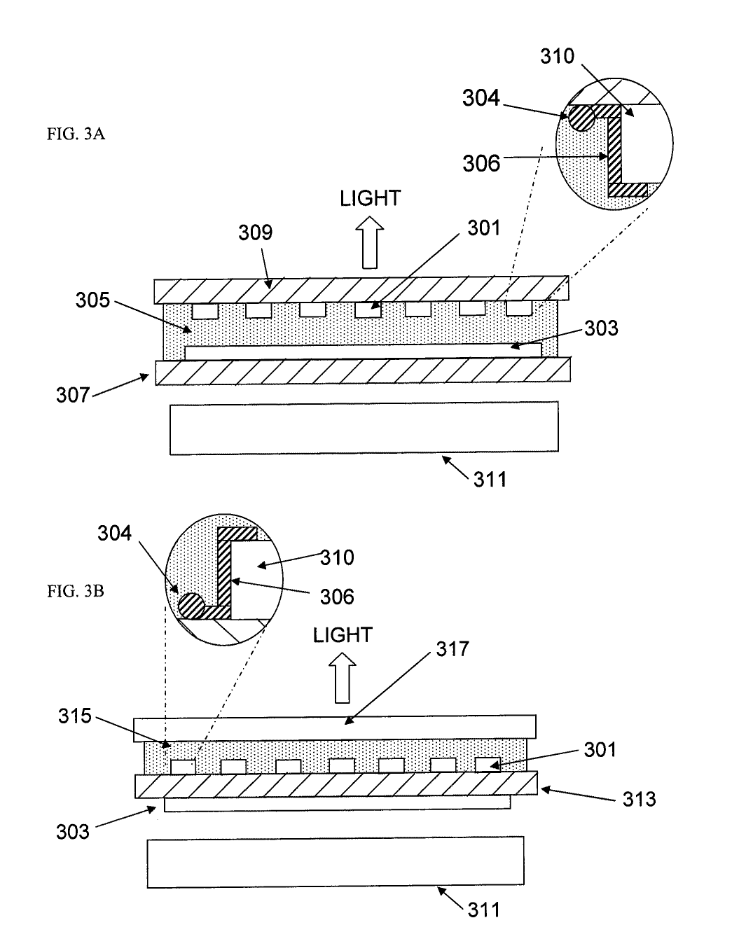

The drive electrodes 103 may be formed from solid areas of transparent conductive material such as ITO. In some examples, the drive electrodes 103 are in the form of ITO strips. Gaps between adjacent drive electrodes 103 may be made as narrow as possible to enhance the ability of the drive electrodes 103 to shield the sense electrodes 101 against noise arising from an underlying light source or display, such as the light source 311 shown in FIGS. 3A or 3B, or from mechanical movement. In some examples, the gap between adjacent drive electrodes may be no more than 200 microns. For example, the gap in FIG. 1 may be from 10-30 microns.

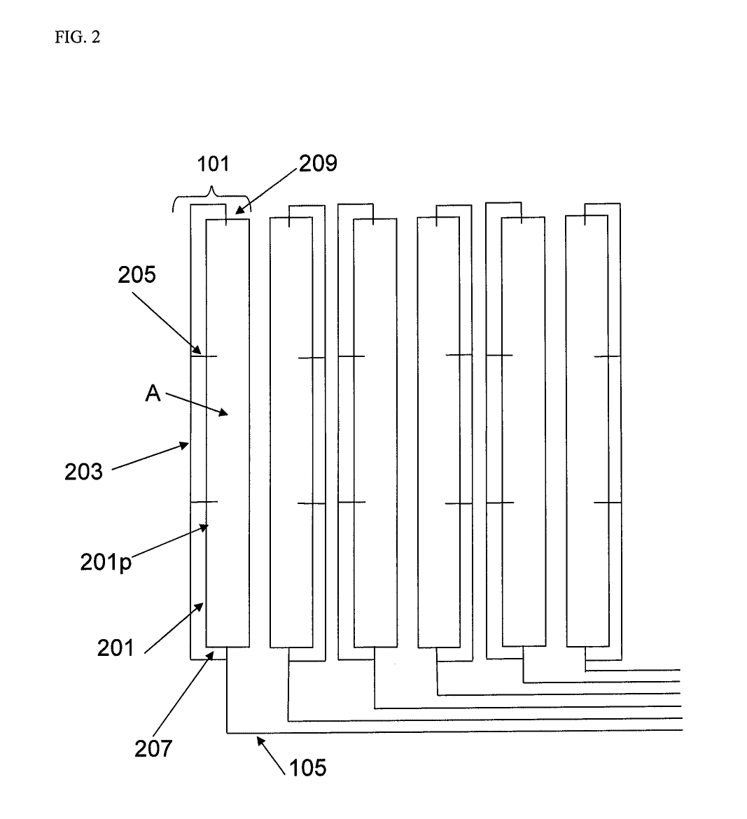

The sense electrodes 101 of FIG. 1 are illustrated in isolation in FIG. 2. Each sense electrode 101 may have a light-transmitting conductor 201 and an auxiliary conductor 203 arranged adjacent to the light-transmitting conductor 201. In the example shown in FIG. 2, the auxiliary conductor 203 is arranged adjacent to the light-transmitting conductor 201, and the light-transmitting conductor 201 and the auxiliary conductor 203 are separate, but connected at the distal end 209. The electrode may further have one or more additional conductive bridges 205 along the length of the sense electrode 101. Each bridge forms an electrical connection between the light-transmitting conductor 201 and the auxiliary conductor 203. The auxiliary conductor 203 may be continuous along at least part of the length of the light-transmitting conductor 201.

The light-transmitting conductor 201 has lower conductivity than the auxiliary conductor 203. The relatively low conductivity of the light-transmitting conductor 201 may result from the light-transmitting conductor 201 being formed from a material of relatively low conductivity. In other examples, the light-transmitting conductor 201 has low relative conductivity because the light-transmitting conductor 201 may be formed in a pattern resulting in relatively high resistivity, such as a pattern having narrow, high resistivity lines.

In the example of FIG. 2, the light-transmitting conductor 201 may be formed from a transparent conductive material, such as ITO. Other suitable transparent conductive materials include, for example, carbon nanotubes and organic conductive materials. Exemplary organic conductive materials include organic conductive polymers such as poly(ethylenedioxythiophene) (PEDOT). The perimeter 201p of the light-transmitting conductor 201 defines an area A. The transparent conductive material may cover substantially the whole of area A to form a solid block of transparent conductive material. The width of each block of transparent conductive material may depend on the application of the position sensing panel. In some examples, the blocks may each independently have a width in the range of about 0.3-1.5 mm.

In another embodiment, the light-transmitting conductor 201 may be formed from an opaque conductive material, such as a conductive metal, in which the opaque conductive metal is sized and patterned to provide gaps in area A through which light may be transmitted. For example, the opaque conductive material may form a pattern such as a mesh patterned in thin conductive lines. For example, the lines can be 10 microns wide. In another example, the lines can be 5 microns wide. An exemplary range is 3-10 microns. Narrower lines reduce their visibility to the naked eye.

By forming sense electrodes 101 from opaque, thin conductive lines, the sense electrodes 101 may cover no more than 10% of the area A. Limiting the coverage of the area A by sense electrodes allows for good transparency of the position-sensing panel.

The auxiliary conductor 203 and conductive bridges 205 may be made from any conductive material suitable to provide relatively high conductivity, for example metals. Suitable metals include copper, silver, gold, aluminum, and tin. However, other metals suitable for use in conductive wiring may also be used for the auxiliary conductor 203 and conductive bridges 205. In some examples, the auxiliary conductor 203 and conductive bridges 205 may be formed from the same material. The auxiliary conductor 203 and conductive bridges 205 may also be formed in the same patterning step.

Depending on the conductivity desired and the material used, the thickness of the auxiliary conductor 203 or the thickness of the conductive bridges 205 may be in the range of from 50 to 250 microns, which is visible to the human eye.

In some examples, the conductive bridges 205 form electrical connections between the auxiliary conductor 203 and the light-transmitting conductor 201. The conductive bridges 205 may contact the light-transmitting conductor 201 at its perimeter only. However in the example of FIG. 2, each of the conductive bridges 205 extends into the area A defined by the perimeter 201p of the light-transmitting conductor 201. In some examples, only one conductive bridge 205 may contact the light-transmitting conductor 201. In the illustrated example, however, more than one conductive bridge 205 may contact each light-transmitting conductor 201.

In the example of FIG. 2, the light-transmitting conductor 201 has a proximal end 207 connected to connecting line 105, and a distal end 209. The conductive bridges 205 may be provided at regular intervals along the length of the light-transmitting conductor 201 and the auxiliary conductor 203, and a conductive bridge may be provided at distal end 209. In another example, only one connecting bridge 205 may be provided, and the location of this bridge may be at or near a point on the light-transmitting conductor that is furthest from a point of connection to a connecting line 105. In other examples, at least one conductive bridge 205 may be at a point closer to the distal end 209 than to the proximal end 207.

The resistance of a conductive path along the light-transmitting conductor 201 between a point on the light-transmitting conductor 201 and connecting line 105 may be relatively high compared to the resistance of the auxiliary conductor 203 or the conductive bridge 205, especially at points near distal end 209. The presence of at least one conductive bridge 205 and the auxiliary conductor 203 provides a conductive path to the connecting line 105 that may be of lower resistance than the path along the light-transmitting conductor 201 alone.

FIGS. 3A and 3B illustrate exemplary arrangements of drive and sense electrodes 303, 301 of an exemplary touch position sensing panel. In both FIGS. 3A and 3B, the sense electrodes 301 may have a light-transmitting conductor 310 and an auxiliary electrode 304. The light-transmitting conductor 310 and the auxiliary electrode 304 may be electrically connected via a conductive bridge 306.

Referring to FIG. 3A, sense electrodes 301 may be provided on a lower or upper surface of a substrate 309 and the drive electrodes 303 may be provided on an upper or lower surface of another substrate 307. The sense electrodes 301 and the drive electrodes 303 may be separated by a layer of non-conducting material 305, such as a pressure-sensitive adhesive. In this example, the drive and sense electrodes 303 and 301 face each other.

FIG. 3A also shows an expanded view of a cross-section of a portion of one of the sense electrodes 301 at a point where a conductive bridge 306 electrically connects an auxiliary electrode 304 and a light-transmitting conductor 310. As can be seen, the auxiliary electrode 304 is separated from the light-transmitting conductor 310 in a manner similar to the auxiliary electrode 203 and the light-transmitting conductor 201 in FIG. 2.

A light source 311, such as a display or a backlight, may be arranged to transmit light through the position sensing panel towards a user.

In another arrangement illustrated in FIG. 3B, the sense electrodes 301 and the drive electrodes 303 may be formed on opposing surfaces of the same substrate 313. In this example, the sense electrodes 301 are on the upper surface of the substrate 313 and the drive electrodes 303 are on the lower surface opposite the upper surface of the substrate 313. As with FIG. 3A, a light source 311 such as a display or a backlight may be arranged to transmit light through the position sensing panel towards a user. A transparent cover sheet 317 may be separated from the sense electrodes 301 by pressure-sensitive adhesive layer 315.

FIG. 3B shows an expanded view of a cross-section of a portion of one of the sense electrodes 301 at a point where a conductive bridge 306 electrically connects an auxiliary electrode 304 and a light-transmitting conductor 310. As with FIG. 3A, the auxiliary electrode 304 is separated from the light-transmitting conductor 310, and a conductive bridge 306 connects the auxiliary electrode 304 to the light-transmitting conductor 310.

Substrates 307, 309, 313 and cover sheet 317 may each be formed from a transparent, non-conductive material such as glass or a plastic. Plastic substrates and cover sheets are suitable to provide flexibility to the position-sensing panel. Examples of suitable plastic substrate materials include, but are not limited to polyethylene terephthalate (PET), polyethylene naphthalate (PEN), or polycarbonate (PC). Examples of suitable plastic materials for the transparent cover sheet 317 include, but are not limited to, polycarbonate and poly(methyl methacrylate) (PMMA).

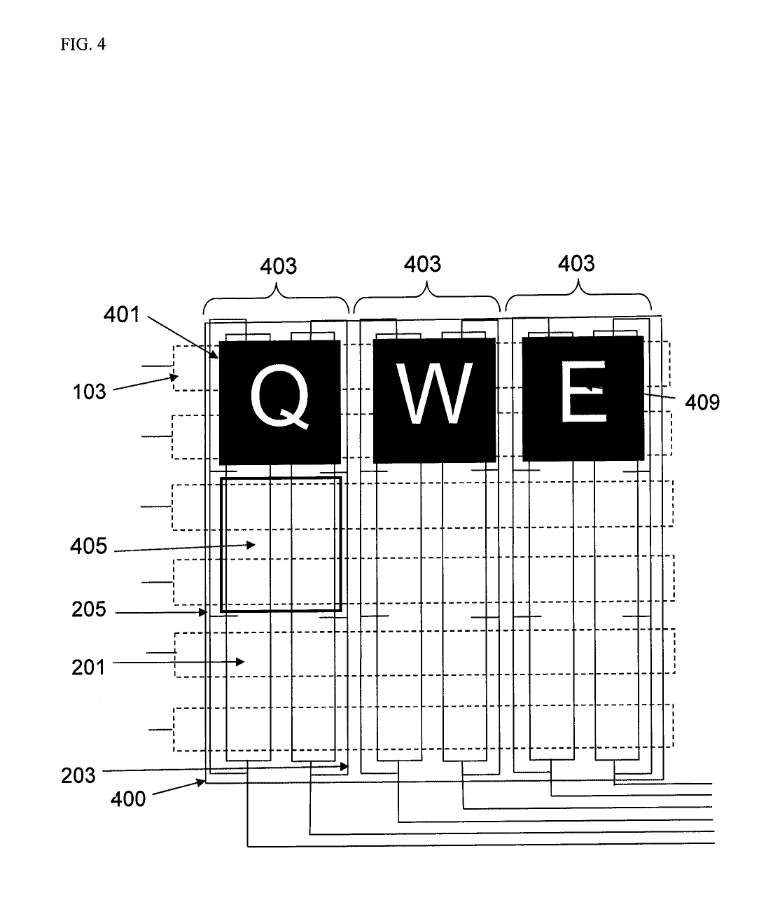

As shown in FIG. 4, a keypad 400 may be provided over the position-sensing panel of FIG. 1 such that individual keys 401 may be arranged over touch-sensitive nodes. The keypad 400 may be formed from plastic materials, and may be formed from a rigid and/or flexible plastic material. A flexible keypad may be used with a flexible position-sensing panel.

FIG. 4 illustrates some of the keys 401 of a keypad 400 overlying a position-sensing panel of FIG. 1. At least part of each key 401 is transparent in order that light emitted from, for example, a backlight positioned behind the position-sensing panel, may be transmitted through the position-sensing panel and through the keys 401. In this example, each key 401 may be opaque except for the character 409 on each key, which is transparent. The characters 409 are visible in low ambient lighting conditions when light is transmitted through the characters 409.

In this example, the auxiliary conductor 203 and the conductive bridges 205 may be formed from an opaque conductive material. Each key 401 may be arranged over the light-transmitting conductor 201 such that light transmitted through the sensor and through the transparent part of the key is not blocked, either in whole or in part, by either the opaque auxiliary conductor 203 or by the opaque conductive bridges 205. In some examples, the auxiliary conductor 203 and conductive bridges 205 may have a thickness of from 50 to 250 microns, which is thick enough to be visible to the human eye. The auxiliary conductor 203 and conductive bridges 205 may be arranged behind opaque regions of the keypad 400 such that the opaque elements of the position-sensing panel are not visible to a user of the keypad 400.

In this example, sense electrodes 101, each having a light-transmitting conductor 201 and an opaque auxiliary conductor 203 joined to the light-transmitting conductor 201 via a conductive bridge 205, are arranged in pairs 403. Each key 401 occupies a key area 405 that may be substantially free of opaque material in the auxiliary conductor 203 or conductive bridges 205. In this arrangement, emission of light from a backlight through the position-sensing panel in the key areas 405 may not be impeded by opaque material in the conductors and bridges. In other embodiments, opaque auxiliary conductors 203 or conductive bridges 205 may be present in one or more key areas 405 but not in areas though which light is to be emitted towards a user, such as the area defined by a transparent key character 409.

Each key area 405 in the example shown in FIG. 4 may extend across two sense electrodes 101 and two drive electrodes 103. It may be appreciated that any number of sense electrodes 101 and drive electrodes 103 may form a single sensing area 405, and that the number of drive and sense electrodes 103, 101 in a key area 409 are not necessarily similar.

In other arrangements, a display may be combined with a position sensing panel. Light emitted from the display may be visible through the position sensing panel.

The auxiliary conductor 203 may be formed from a transparent conductive material. The auxiliary conductor 203 may also be formed from an opaque conductive material sized and patterned to allow transmission of light through the area of the auxiliary conductor 203. The conductivity of the auxiliary conductor 203 may also be higher than that of the light-transmitting conductor 201.

The display may be of various types, for example, liquid crystal, active matrix liquid crystal, electroluminescent, electrophoretic, plasma, cathode-ray display, organic light-emitting device (OLED), or the like. Light emitted from the display passes through the position sensing panel in order to be visible to a viewer of the display.

The process of manufacturing a position-sensing panel of any of the types illustrated in FIGS. 1-4 may include patterning of electrodes. For example, sense electrodes 301 may be manufactured with a light-transmitting conductor 310, an auxiliary conductor 304, and conductive bridges 306 on a surface of an appropriate substrate such as substrate 309 in FIG. 3A, or the upper surface of substrate 313 in FIG. 3B.

The process of manufacturing a position-sensing panel of any of the types illustrated in FIGS. 1-4 may also include patterning drive electrodes, for example ITO drive electrodes, on a surface of a substrate. For example, drive electrodes 303 may be patterned on a surface of a substrate 307, as illustrated in FIG. 3A. In other examples, drive electrodes 303 may be patterned on a lower surface of the substrate 313 opposing the upper surface, as illustrated in FIG. 3B.

A process of patterning either drive electrodes or the light-transmitting conductors of the sense electrodes from ITO may include depositing a positive or negative resist over unpatterned ITO on a substrate; exposing the photoresist to UV light through a mask of the appropriate pattern; developing the resist by washing away unexposed resist with a solvent, and etching away the exposed ITO areas using a suitable etchant. The exposed photoresist may be removed by using a suitable solvent. An example of a suitable etching liquid for use in removing exposed ITO is an etching acid. Examples of suitable solvents for the photoresist include organic solvents. Other suitable positive and negative photoresists, etching liquids and photoresist removal liquids may be used.

In other examples, ITO may be deposited on the substrate by sputtering ITO onto the substrate using a shadow mask having a pattern suitable for formation of electrodes in a shape suitable for use as an electrode.

A transparent conductive organic material such as PEDOT may be used to form drive electrodes or the light-transmitting conductors of sense electrodes by a printing process such as screen printing or inkjet printing or etching.

The process of patterning the auxiliary conductors and conductive bridges over sense electrodes may include deposition of a relatively high conductivity material, for example metal, by evaporation through a mask in the appropriate pattern. If the light-transmitting conductors of the sense electrodes will use a mesh pattern of an opaque conductive material, then the light-transmitting conductors may be formed by a similar processing as the auxiliary conductors and the conductive bridges.

In some examples, the auxiliary conductors and conductive bridges may be formed by a printing process in which a printable conductive material or conductive material precursor is printed to form the sense electrode pattern. In the case where a precursor ink is used, the process may involve treating the precursor ink to convert the ink to a conductive material, such as by electroless plating. Exemplary printing methods include inkjet printing and screen printing. In other examples, the substrate may be uniformly coated with a catalytic photosensitive ink which may be exposed to UV light through a photomask or vector-exposed to UV light from a laser or other suitable light source, and rinsed with solvent to wash away the unexposed ink. The remaining ink may be immersed in a metal plating bath to form the auxiliary electrodes and the conductive bridges and possibly to form a pattern. If the light-transmitting conductors use a mesh pattern of an opaque conductive material, then the light-transmitting conductors of the sense electrodes may be formed by a similar process as the auxiliary conductors and conductive bridges.

A gap of any size may be provided between the auxiliary conductor and the light-transmitting conductor. A gap of at least 0.25 mm may avoid unintentional overlap of the auxiliary conductor and light-transmitting conductor during printing.

The conductive bridges may be patterned so as to contact the perimeter only of the light-transmitting electrodes. In other examples such as that shown in FIG. 2, the conductive bridges 205 may extend into the area of the light-transmitting electrodes 201. This may reduce the risk of a conductive bridge failing to electrically connect to a light-transmitting electrode following printing.

Connecting lines for connecting sense electrodes to a control unit of a position-sensing panel may be formed in a similar process as formation of the auxiliary conductor or conductive bridges.

In another example, auxiliary conductors and conductive bridges may be formed on the substrate first, followed by formation of light-transmitting conductors using one of the methods described above.

Although some exemplary processes are given above for forming drive electrodes and sense electrodes, it will be appreciated that any suitable way of forming these electrodes can be used in conjunction with the disclosure provided herein.

The touch position sensors described above can be attached to numerous electronic devices, such as computers, personal digital assistants, satellite navigation devices, mobile phones, portable media players, portable game consoles, public information kiosks, point of sale systems, etc. Any of these electronic devices may include a central processor or other processing device for executing program instructions, an internal communication bus, various types of memory or storage media such as RAM, ROM, EEPROM, cache memory, disk drives, etc., for code and data storage, and one or more network interface cards or ports for communication purposes.

Various modifications may be made to the examples described in the foregoing, and any related teachings may be applied in numerous applications, only some of which have been described herein. It is intended by the following claims to claim any and all applications, modifications and variations that fall within the true scope of the present teachings. For example, although the examples provided herein describe a sense electrode having a light-transmitting conductor, an auxiliary conductor and one or more conductive bridges, it will be appreciated that a drive electrode may likewise have a light-transmitting conductor, an auxiliary conductor and one or more conductive bridges and that the drive electrodes or sense electrodes of a touch-sensitive panel may have a light-transmitting conductor, an auxiliary conductor and one or more conductive bridges. In other examples, the auxiliary conductor may be embedded in the transparent electrode without a conductive bridge.

1. A touch position sensing panel comprising:
a plurality of first electrodes arranged in a first direction;
at least one of the first electrodes comprising:
a light-transmitting conductor having a first conductivity;
an auxiliary conductor associated with the light-transmitting conductor having a second conductivity higher than the first conductivity; and
at least one conductive bridge of conductivity higher than the first conductivity, connecting the auxiliary conductor to the light-transmitting conductor.

2. The touch position sensing panel of claim 1, further comprising:
a plurality of second electrodes arranged in a second direction different from the first direction such that the first and second electrodes overlap.

3. The touch position sensing panel of claim 2, wherein the second electrodes are comprised of a transparent material.

4. The touch position sensing panel of claim 3, wherein the transparent material comprises ITO.

5. The touch position sensing panel of claim 1, wherein the auxiliary conductor is separated from and adjacent to the light-transmitting conductor.

6. The touch position sensing panel of claim 1, wherein a plurality of conductive bridges are provided between the auxiliary conductor and the light-transmitting conductor.

7. The touch position sensing panel of claim 1, wherein the auxiliary conductor is comprised of an opaque material.

8. The touch position sensing panel of claim 1, wherein the light-transmitting conductor comprises ITO.

9. A touch sensing device comprising:
a touch position sensing panel comprising:
a plurality of first electrodes arranged in a first direction, at least one of the first electrodes comprising:
a light-transmitting conductor having a first conductivity;
an auxiliary conductor associated with the light-transmitting conductor having a second conductivity higher than the first conductivity; and
at least one conductive bridge of conductivity higher than the first conductivity, connecting the auxiliary conductor to the light-transmitting conductor; and
a plurality of second electrodes arranged in a second direction different from the first direction such that the first and second electrodes overlap at nodes of the panel;
a keypad arranged over the touch position sensing panel and having a plurality of keys; and
a light source for emitting light towards the keypad and through the touch position sensing panel, at least one key of the keypad having a transparent region to allow light from the light source incident on the key to pass through the key.

10. The touch sensing device of claim 9, wherein the second electrodes are comprised of a transparent material.

11. The touch sensing device of claim 10, wherein the transparent material comprises ITO.

12. The touch sensing device of claim 9, wherein the auxiliary conductor is separated from and adjacent to the light-transmitting conductor.

13. The touch sensing device of claim 9, wherein the auxiliary conductor comprises an opaque material.

14. The touch sensing device of claim 9, wherein the light-transmitting conductor comprises ITO.

15. A touch position sensing panel comprising:
a plurality of sense electrodes arranged in a first direction, at least one of the sense electrodes comprising:
a light-transmitting conductor having a first conductivity;
an auxiliary conductor associated with the light-transmitting conductor having a second conductivity higher than the first conductivity; and
at least one conductive bridge of conductivity higher than the first conductivity, connecting the auxiliary conductor to the light-transmitting conductor.

16. The touch position sensing panel of claim 15, further comprising:
a plurality of drive electrodes arranged in a second direction different from the first direction such that the sense and drive electrodes overlap.

17. The touch position sensing panel of claim 16, wherein the drive electrodes are comprised of a transparent material.

18. The touch position sensing panel of claim 17, wherein the transparent material comprises ITO.

19. The touch position sensing panel of claim 15, wherein the auxiliary conductor is separated from and adjacent to the light-transmitting conductor.

20. The touch position sensing panel of claim 15, wherein the auxiliary conductor is comprised of an opaque material.

21. The touch position sensing panel of claim 15, wherein the light-transmitting conductor comprises ITO.

22. A touch position sensing panel comprising:
a plurality of first electrodes arranged in a first direction;
at least one of the first electrodes comprising:
a light-transmitting conductor having a length in the first direction and having a first conductivity; and
an auxiliary conductor associated with the light-transparent conductor having a length in the first direction and having a second conductivity higher than the first conductivity, wherein:
the auxiliary conductor extends continuously from a proximal end of the light transmitting conductor to a point closer to a distal end of the light-transmitting conductor than to the proximal end, and
the auxiliary conductor connects to the light-transmitting conductor at at least one point along the lengths of the auxiliary conductor and the light-transmitting conductor.

23. The touch position sensing panel of claim 22, wherein the auxiliary conductor connects to the light-transmitting conductor via a connective bridge.
